(19) United States
(12) Patent Application Publication
(10) Pub. No.: US 2017/0073086 A1
(43) Pub. Date: Mar. 16, 2017

(54) SHUTTER CAPABLE OF OBSCURING LIGHT

(71) Applicant: Airbus Operations S.A.S., Toulouse (FR)

(72) Inventor: Phillip Vigneau, Seysses (FR)

(73) Assignee: Airbus Operations S.A.S., Toulouse (FR)

(21) Appl. No.: 15/264,913

(22) Filed: Sep. 14, 2016

(30) Foreign Application Priority Data
Sep. 15, 2015 (FR) 15 58606

(51) Int. Cl. B64F 5/00; F16B 47/00

(52) U.S. Cl. CPC B64F 5/0045; F16B 47/00

(57) ABSTRACT

A shutter for masking a surface allowing radiation, to pass at least partially. includes a panel and a skirt forming, with the panel, an enclosure which, when applied to the surface, prevents the passage of at least a determined radiation, and at least one partial vacuum-based fixing system for temporarily fixing the enclosure onto said surface to which it is intended to be applied. The fixing system includes at least one vacuum pump fixed onto the panel in such a way as to be able to be handled from the outside of said enclosure and to create the vacuum in at least one sucker fixed onto the panel on the side of said enclosure, and the dome of which is turned toward the outside of the enclosure. The vacuum pump has a handle having a pushbutton making it possible, each time it is pressed, to suck air into the sucker or suckers.

### FIELD OF THE INVENTION

The present invention relates to a shutter intended to totally and temporarily mask a surface allowing a radiation, such as a light radiation for example, to pass at least partially. More particularly, the present invention applies to a shutter that can be used to occult a glazed surface of an enclosed space, closed like the cockpit of an aircraft, to make it possible, according to one possible application, to obtain a total darkness inside said enclosed space.

### BACKGROUND OF THE INVENTION

In tests on the ground performed on an aircraft, it is necessary to check that there is no leak of light between or onto the visual units of the cockpit. To be able to detect them, it is essential to plunge the cockpit into total darkness.

The solution currently used is to make use of a tarpaulin which is installed over all of the nose cone of the aircraft. Now, the current aircraft can have very large dimensions. This means tarpaulins of very large size that are difficult to handle and to install. For some aircraft like the A380 (registered trademark), it is even necessary to make use of complex and imposing installations such as a jib crane and a traveling crane to be able to put in place or remove a tarpaulin on or from a surface of critical size. Furthermore, with the operation to put in place or remove the tarpaulin being heavy and tedious, it takes a lot of time.

Moreover, the operation is difficult since it is necessary to preserve the many systems protruding from the surface of the cockpit like the probes for example, some of which can exhibit a certain brittleness.

Finally, once the tarpaulin is fitted, there is the problem of keeping it in place and all the more so since it exhibits a not inconsiderable wind catch.

The document DE 200 02 008 discloses a heat and theft protection screen for a window of a motor vehicle. The screen comprises a sheet of insulating material such as plastic foam provided with a bearing lip on its periphery made of deformable material such as rubber. The bearing lip protrudes to form a thermally-insulating air space between the sheet and the windshield. The screen is provided with a sucker in its central part. The sucker-based fixing system is impractical for placing the screen on the window.

### BRIEF SUMMARY OF THE INVENTION

An aspect of the present invention proposes a device that makes it possible to mitigate the problem of bulk of a tarpaulin and of awkward installation.

For this, an aspect of the present invention proposes a shutter making it possible to mask a surface which allows a radiation to pass at least partially, comprising a panel and a skirt forming, with the panel, an enclosure which, when applied to the surface, prevents the passage of at least a determined radiation, the shutter being provided with at least one partial vacuum-based fixing system making it possible to temporarily fix the enclosure onto the surface to which it is intended to be applied, wherein the fixing system comprises at least one vacuum pump fixed onto the panel in such a way as to be able to be handled from the outside of said enclosure and to create the vacuum in at least one sucker fixed onto the panel on the side of said enclosure and the dome of which is turned toward the outside of the enclosure, the vacuum pump taking the form of a handle, the handle being provided with a pushbutton making it possible, each time it is pressed, to suck air into the sucker or suckers.

Because of this, the panel and the skirt making it possible to adapt to the size of the surface to be occulted and being kept in immediate proximity thereto by virtue of the partial vacuum-based fixing system, the device no longer poses a problem of bulk. The shutter can be handled, and is simple and effective since the panel and the skirt occult the surface in a seal-tight manner. Moreover, the fixing system makes it possible, using the external handle incorporating a vacuum pump which can be actuated by a pushbutton, to create the vacuum inside the sucker located on the side of the enclosure: fitting is therefore easy and rapid.

The shutter offers at least one of the following optional features, taken in isolation or in combination.

The pump is connected to each of the associated suckers using a flexible pipe.

The shutter comprises two vacuum pumps arranged optimally for the handling of the shutter by grasping with one hand the handle of the pump and with the other hand the handle of the pump to be easy, one or more suckers being associated with the corresponding pump.

The skirt comprises a seal fixed to the panel so as to form said enclosure.

The skirt comprises a brush of threads fixed to the panel so as to form said enclosure.

The brush is closed on itself so as to form an enclosed surface.

The brush forms an enclosed surface surrounding that of the seal.

The brush comprises a double row of threads.

### BRIEF SUMMARY OF THE DRAWINGS

Other aims, advantages and features of the invention will become apparent on reading the following description of the shutter according to the invention, given as a nonlimiting example with reference to the attached drawings in which:

FIG. 1 represents a schematic view in partial perspective of a cockpit provided with a number of surfaces to be occulted, one of them provided with the shutter according to an embodiment of the invention;

FIG. 2 represents a schematic view in perspective from the side of the shutter according to another embodiment of the invention;

FIG. 3 represents a simplified schematic view in cross-sectional perspective of the shutter according to an embodiment of the present invention;

FIG. 4 represents a schematic plan view from the side and with transparency of the shutter represented in FIG. 2;

FIG. 5 represents a partial cross-sectional view from the side of a peripheral part of the shutter according to an embodiment of the present invention;

FIG. 6 represents a partial cross-sectional view from the side of a part of the shutter bearing a handle according to an embodiment of the present invention;

FIG. 7 represents a plan schematic view from the side and with transparency of an embodiment other than that of FIGS. 1 and 2 of the shutter; and

FIG. 8 represents a simplified perspective view with transparency of a carriage making it possible to store and transport the shutter according to an embodiment of the present invention.

### DETAILED DESCRIPTION

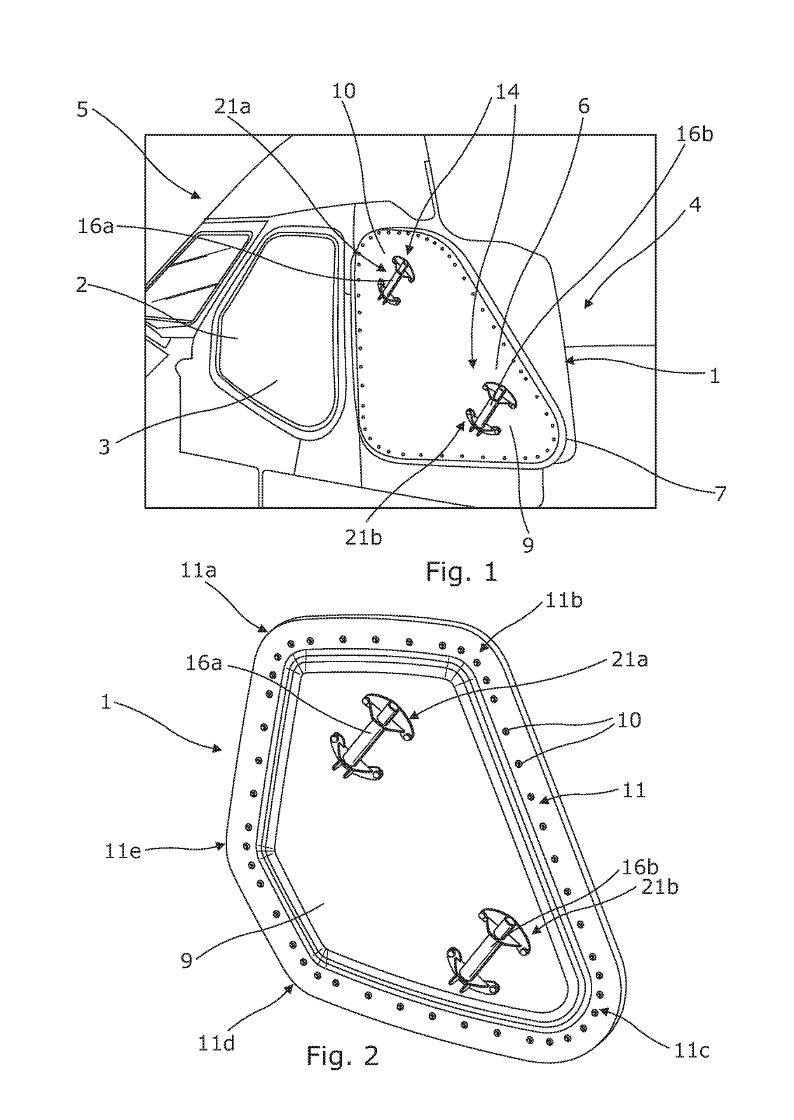

As FIG. 1 shows, the present invention relates to a shutter 1 intended to be applied temporarily to a surface 2 of which a part, called surface to be masked 3, allows a radiation, and for example an electromagnetic radiation or even more specifically solar, light radiation, to pass at least partially. The surface 2 is generally a surface to be masked in an enclosed, closed space like a hall, a room, premises, a passenger compartment or similar. In the application illustrated, the surface is a window in a cockpit 4 of an aircraft 5.

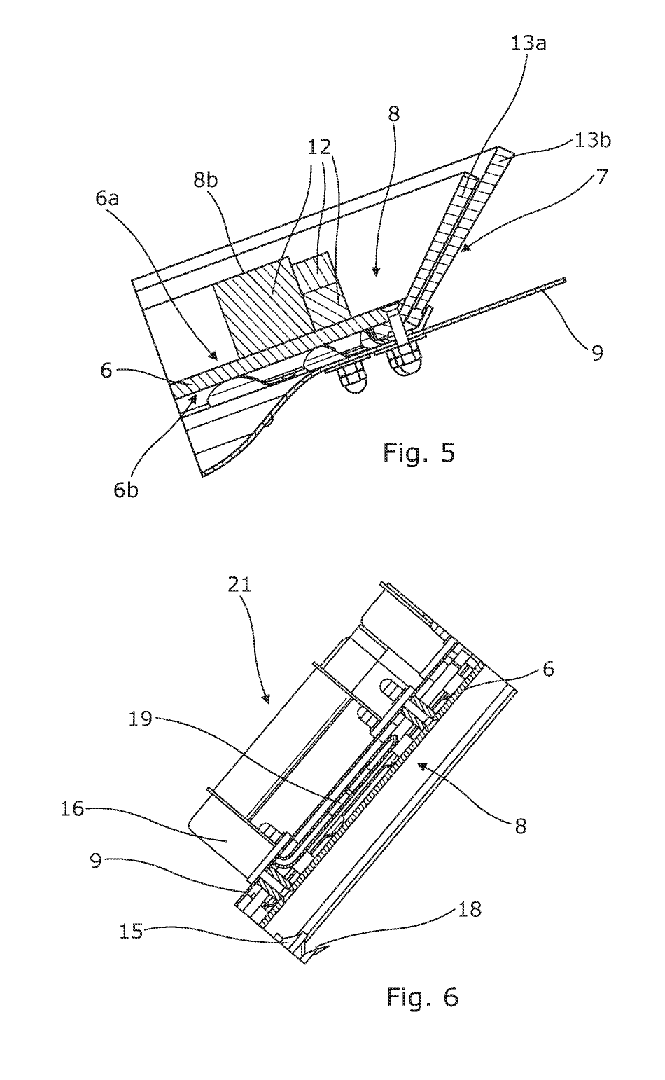

The shutter 1 comprises a panel 6 and a skirt 7 with which it forms an open enclosure 8 (visible in FIGS. 5 and 6) offering an internal space. The face of the panel 6 from which the skirt 7 extends to form the enclosure is designated by the reference 6a. The other face will take the reference 6b. The panel 6 and the skirt 7 can have any geometry provided that the dimensions of the surface whose perimeter is the free edge 8b of the enclosure 8 are greater than or equal to that of the surface 3 to be masked (window 3) or, more specifically, that the free edge of the enclosure 8 is superposed on or surrounds the peripheral edge of the surface 3 to be masked. If the dimensions are less than those of said surface 3 to be masked or, more specifically, a part of the surface 3 to be masked is located outside of the enclosure 8 when the enclosure 8 is positioned on the surface 2, the shutter cannot completely occult the surface 3 to be masked and the desired function is not fulfilled. If these dimensions are much greater, the benefit of a handleable device with little bulk is lost. On the other hand, the shutter can be used on a number of surfaces 3 to be masked of different geometry and size. In the embodiment illustrated in FIG. 1, the shutter 1 has a form substantially identical to that of the surface 3 to be masked onto which it is intended to be applied. The result is a device that is lighter and easy to handle.

According to a particular embodiment of the invention, the panel 6 is produced in a semi-rigid material so as to closely follow the form of the surface 2 onto which it is intended to be applied. In the application of the windows 3 of an aircraft 5, the cockpit 4 and notably the windows 3 have an overall concave form. The semi-rigidity allows the panel 6 to closely follow the concavity of the cockpit 4 and, more particularly, of the window 3 when the panel is applied thereto. The panel 6 is produced, for example, in a plastic material such as polycarbonate or even high density polyethylene (PEHD). Other types of plastic can be suitable. The plastic material has an opaque black color so as to form a screen to the light and at least to the visible light to obtain a total darkness in the location provided with the surface 3 to be masked and, in our example, in the cockpit 4. According to the desired application, another material could be used, for example a material that does not allow infrared radiation to pass so as to form a barrier to heat. The material of the panel 6 is chosen also so as to offer an acceptable weight for an operator handling it and a sufficient rigidity to bear the skirt 7 and not to be damaged when fixing the shutter 1 onto the surface 2 as will be seen later in the description.

According to a particular embodiment, the panel 6 is covered with a fabric 9 forming a sunscreen to reinforce the seal-tightness at least to visible light. The material chosen for the fabric could be chlorosulfonated polyethylene. As seen previously, another material could be chosen according to the desired application and, for example, to form an obstacle to heat, it is necessary to block the passage of other radiations. The fabric 9 is riveted onto the panel 6 by a series of rivets 10 provided on the peripheral edge 11 of the panel 6, but also could be stitched or fixed to the panel by any type of known means. A greater number of rivets is provided on the non-rectilinear outlines 11a, 11b, 11c, 11d, 11e of the edge 11 of the panel 6. The fabric 9 constitutes a first filter and the panel 6 constitutes a second filter to prevent one or more determined radiation(s) and, in the example illustrated, the outside light from passing through the shutter and from penetrating, in the present example, into the cockpit. The shutter therefore presents a double filter to the outside light.

The skirt 7 can comprise a flexible seal 12 fixed onto the panel 6 and extending from one 6a of its faces outward. The seal 12 is closed on itself so as to form an enclosed surface. This surface in conjunction with the panel 6 forms said enclosure 8. According to the embodiment illustrated, the seal 12 is fixed along the free edge of the panel 6 over its entire perimeter. According to a particular embodiment, the seal 12 is a profile member made of flexible material like rubber and, for example EPDM (ethylene propylene diene monomer). The profiled seal forms, for example, a closed cylindrical surface with an axis at a right angle to the panel 6. According to a particular embodiment illustrated in FIG. 5, several seals can be joined contiguously and possibly also superposed. The seal(s) 12 form(s), with the panel 6, a tight barrier to one or more radiation(s), here the light, not allowing light to pass through and penetrate into the cockpit or, more generally, a space that is enclosed and tight at least to visible light.

The skirt 7 can comprise a brush 13 of threads, fibers, hair, filaments, fibers or equivalent generically called threads, fixed to the panel 6 and extending from one 6a of its faces outward. The brush is closed on itself so as to form an enclosed surface. This surface in conjunction with the panel 6 forms said enclosure 8.

The shutter 1 comprises the seal 12, the brush 13 or a combination of the seal 12 and of the brush 13. In the latter case, the enclosure 8 is formed by the seal 12 and the panel 6 (case illustrated in the figures). The brush 13 is then an additional barrier surrounding said enclosure 8. The seal 12 and the brush 13 are fixed side by side, in parallel. The brush 13 forms an enclosed surface surrounding that of the seal 12. The threads (threads, fibers, hair, filaments, fibers or equivalent) used to form the brush 13 are flexible enough to be deformed. As will be seen later, upon the fixing of the shutter 1, the panel 6 is offered up to the surface 2: since the seal 12 and the brush 13 consist of flexible material they are capable of being deformed to close the enclosure 8 and tightly occult the surface 3 to be masked.

The brush 13 consists of at least one row of flexible threads and, for example, of two almost parallel rows 13A, 13B as shown in FIG. 5. It is also possible to form a brush with threads not arranged in rows. It is sufficient for the threads to form a barrier to the light and, in the application illustrated, at least to the visible light. They are preferably of opaque black color. The threads of the brush 13 can for example consist of nylon.

The shutter 1 is provided with means 14 for fixing by partial vacuum onto the surface 2.

According to the embodiment illustrated, the fixing means 14 comprise at least one suction gripping device 15 designated hereinbelow by the term sucker, associated with a manual vacuum pump 16. The sucker can take any known form. In the embodiment illustrated in the drawings, the sucker has a bell-shaped part forming a cavity 17. The sucker 15 has a rim 18 of flared form making it possible to improve the seal-tightness with the surface 2 onto which it is intended to be applied. The material chosen for the sucker is a strong and tight material with a flexibility such that the sucker can be adapted to non-planar walls likely to exhibit an irregular relief. The sucker can consist for example of rubber. The vacuum pump 16 is arranged on the panel 6 so as to extract the air inside the sucker 15 to secure the shutter onto the surface 2. The pump 16 is connected with the sucker using a pipe 19 that is flexible so as to be easily deformed to link the pump 16 to each of the associated suckers. The pipe 19 can for example be produced in silicone. The vacuum pump 16 has means of known type making it possible to actuate the extraction of the air and therefore operate by partial vacuum, namely reduction of the pressure in the sucker 15 and specifically in the cavity 17. In the embodiment illustrated in FIG. 2, the means take the form of a pushbutton 20. Each time the button 20 is pressed, a determined volume of air is extracted from the cavity 17. Since the vacuum pumps are systems of known type, no detailed description thereof is given. An opening system in the form for example of an inlet check valve of any known type is also provided to allow air to be discharged and the shutter to be detached as will be described later.

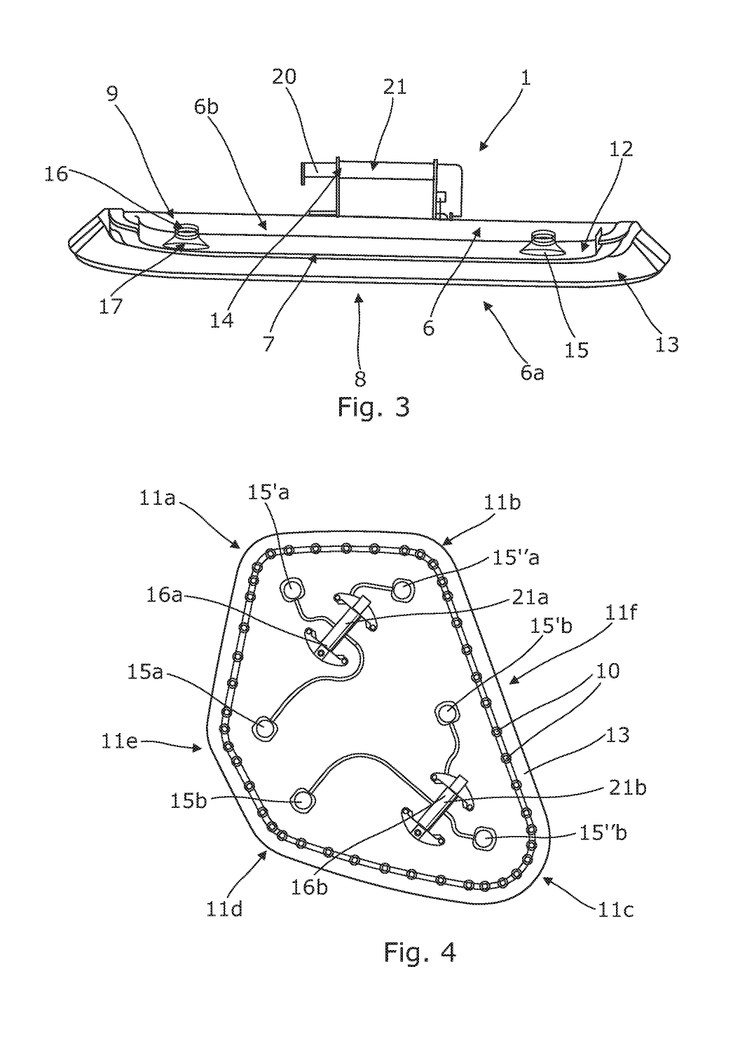

The pump 16 also offers means making it possible to handle the shutter 1. According to the particular embodiment illustrated in FIGS. 1 to 4, these means take the form of a handle 21 on the side of the face 6b of the panel 6.

Still according to the particular embodiment illustrated in FIGS. 1 and 2, the shutter comprises two vacuum pumps 16a and 16b arranged optimally for the handling of the shutter 1 by grasping with one hand the handle 21a of the pump 16a and with the other hand the handle 21b of the pump 16b to be easy. The pumps are located for example at two opposite ends of the panel 6 and/or the pumps are located on a line which passes over or close to the center of gravity. In the embodiment illustrated in FIG. 1, the surface 3 to be masked has an overall right-angled triangle form. The pumps 16a and 16b are located close to the two non-right-angled corners.

The pumps 16a and 16b are associated respectively with three suckers 15a, 15′a, 15″a and 15b, 15′b, 15″b. The suckers are positioned to ensure an optimized fixing according to the geometry of the panel 6. In the case illustrated in FIG. 4, the panel 6 is a pentagon and each sucker 15a, 15′a, 15″a, 15b, 15′b, 15″b is placed in line with a corner 11a, 11b, 11c, 11d, 11e formed between two sides of the pentagon or between two of these suckers in the case of a side 11f of greater length.

A light indicator can be provided on the pumps 16 to indicate that the air contained in the sucker or suckers 15 associated with the corresponding pump has been sucked out.

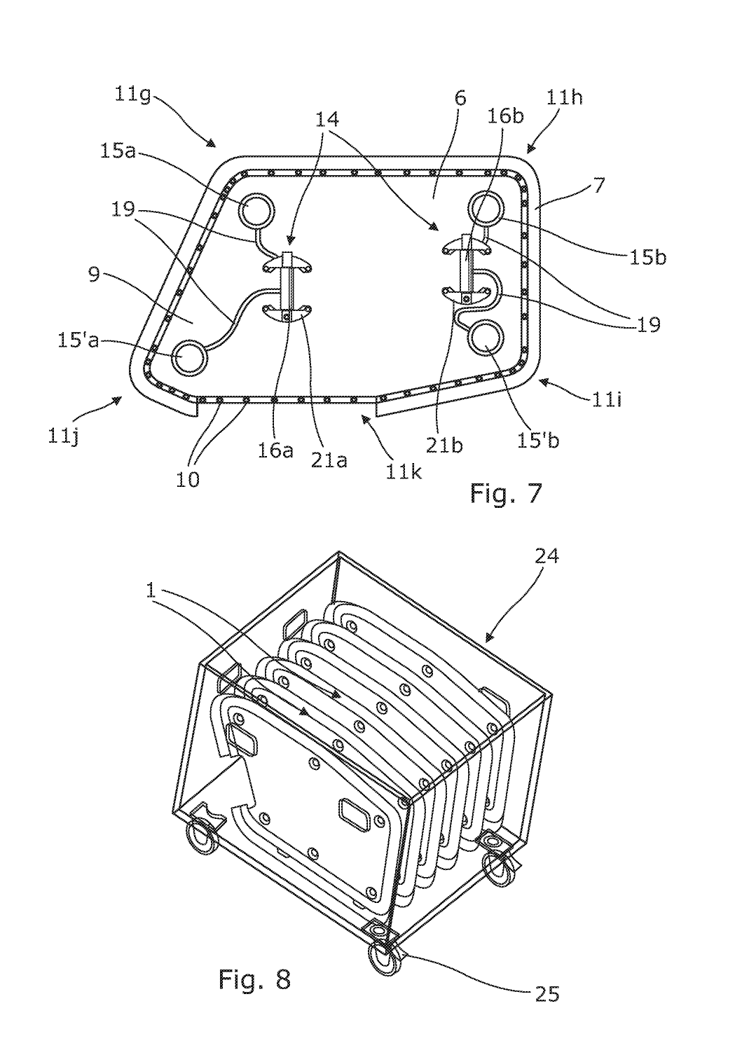

The number of suckers 15 is adapted according to the form, the size and the weight of the panel 6. Thus, in a substantially triangular form, at least three suckers could be used, one at each corner. In a substantially square/rectangular form as illustrated in FIG. 7, four suckers 15a, 15′a, 15b, 15′b can be envisaged, one at each corner. As seen previously, in the example illustrated in FIG. 2, the fixing means comprise six suckers.

It should be noted that, in the embodiment illustrated in FIG. 7, the number of rivets 10 is increased on the non-rectilinear edges 11g, 11h, 11i, 11j of the shutter 1. On the other hand, more rivets are not provided on the longest side 11k even though it has a slight curvature because of being almost rectilinear, the curvature being small. The number of rivets is adapted according to the geometry.

According to another embodiment, the handles 21 could be independent of the means 14 for fixing the panel onto the structure.

In order to avoid any lifting of the shutter in the middle of testing of the systems of the cockpit, tests which can be costly, according to the embodiment illustrated, the fixing means are redundant. Thus, the fixing means comprise at least two vacuum pumps 16 associated with two distinct suckers 15 so that, if one of them comes loose or is damaged, the securing is ensured by the other.

The set of shutters intended for a particular application and, for example, to ensure the darkness of a cockpit of an aircraft of a given model can be stored in one and the same carriage 24 as illustrated in FIG. 8. The shutters 1 are stored vertically, parallel alongside one another. The carriage is provided with castors 25 to ensure the movement of the set of shutters manually by a single operator. A towbar can be provided to allow the carriage to be towed by a vehicle with an engine. The carriage can also comprise housings to receive the forks of a fork-lift truck.

The shutter 1 operates as follows:

The operator grasps the shutter 1 by the handles 21 provided for this purpose. In the embodiment illustrated in FIG. 2, the operator grasps the two handles 21a and 21b with his or her two hands.

The operator positions the shutter 1 on the surface 2 and, in the present case, on the cockpit 4. More specifically, in the embodiment illustrated in FIG. 1, the free edge of the shutter 1 and, more particularly, the free edge of the enclosure 8, namely the free edge of the seal 12 is placed over the surface 2 and more particularly over the seal which surrounds the window 3 to render the link between the window 3 and the structure of the cockpit 4 tight. The free edge of the seal 12, once installed on the seal of the window 3, makes it possible to tightly close the enclosure 8.

The operator applies the fixing means 14 provided. In the embodiment illustrated, the operator actuates the vacuum pumps 16 by pressing several times on the button 20: air is extracted little by little from the suckers 15 until the indicator lights up to indicate that the air contained in the sucker or suckers associated with the corresponding pump has been sucked out. Under the effect of the deformation of the dome 17 of the suckers 15 from which the air is sucked by the vacuum pumps, the panel 6 is fixed directly by the suckers 15 to the surface 2.

In the case of a panel 6 of dimensions greater than the surface 3 to be masked, the suckers 15 could then be fixed to the part of the surface 2 located outside of the surface 3 to be masked. Alternatively, the seal 12 can have a thickness such that it extends beyond the surface 3 to be masked.

In this way, the fixing means hold the shutter against the surface 2. The enclosure 8 that is tight to said radiation(s), i.e. here to light and notably to the visible light, is pressed against the surface 2 over the part located around the surface 3 to be masked, even against the peripheral edge of the surface 3 to be masked, even onto the actual surface 3 to be masked. In this way, the shutter totally occults the surface 3 to be masked and makes it possible to form a barrier to the desired radiation(s) and, for example, to those of daylight to prevent it from penetrating into an enclosed space such as, in the example illustrated, the cockpit.

The panel 6 moves closer to the surface 3 to be masked through the effect of the fixing means by virtue of the flexibility of the skirt 7, namely, in the embodiment illustrated, by virtue of the flexibility of the seal 12 and of the threads of the brush 13.

For each window 3 of the cockpit 4, a shutter 1 is provided with a corresponding form. Thus, in the example illustrated in FIG. 1, the cockpit comprises 6 windows, only three are visible. The operator must therefore install 6 shutters in succession. Once all the shutters are installed on each window of the cockpit, a total darkness is produced inside the cockpit that makes it possible to perform the tests.

When the panel 6 has to be removed and, for example in our application, when the tests in the cockpit are completed, the operator actuates the air inlet check valves or equivalent making it possible to detach the fixing means, here the suckers 15. In the embodiment illustrated, he or she begins by grasping the handles 21a and 21b then opens up the domes 17 of the suckers 15 to the air. He or she can thus easily detach the shutter 1 from the surface 2.

There are many advantages offered by the shutter 1. Its reduced bulk by virtue of its form matching the surface 3 to be masked that it has to occult, the handles 15, 18 and simple fixing means make it handleable, practical, easy to assemble and dismantle. Since most of the components of the shutter are made of plastic material, the result is a lightweight device which reinforces its practical aspect and limits the weight of a system provided with one or more shutters and, in one of the examples described, the weight of an aircraft provided with test systems. It adapts to numerous structures, it avoids any damage, scratching to the paintwork because of the flexible materials used. It also avoids all the drawbacks mentioned, namely making use of complex installation equipment and mitigating the problem of securing and catching of the wind of the tarpaulins. It is capable of being used in any type of climate, day or night, with a relative humidity of the air that can range up to 90%, with temperatures that can vary from −40° to +45°.

As seen previously, the present invention is not limited to the aeronautical field. The shutter 1 according to an embodiment of the present invention could be used in many other technical fields in which it is advantageous to have a shutter offering the abovementioned advantages. Thus, for example, the shutter could be used as a sunscreen in a vehicle or a building by using materials that make it possible to form a barrier to the corresponding radiations. It could, according to another example, be used to avoid icing on the windows of a vehicle parked outside overnight. The shutter then has a rectangular form such as that presented in FIG. 7 not requiring more than four suckers associated with two vacuum pumps calibrated so as to make it possible to secure the shutter for a minimum of approximately 12 hours.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A shutter for masking a surface allowing a radiation to pass at least partially, the shutter comprises:
a panel;
a skirt forming, with the panel, an enclosure which, when applied to the surface, prevents the passage of at least a determined radiation; and
at least one partial vacuum-based fixing system making it possible to temporarily fix the enclosure onto the surface to which the shutter is intended to be applied, wherein the fixing system comprises:
at least one vacuum pump fixed onto the panel in such a way as to be able to be handled from the outside of said enclosure and to create the vacuum in at least one sucker fixed onto the panel on the side of said enclosure ,a dome of the at least one sucker is turned toward the outside of the enclosure, the vacuum pump having a handle, the handle comprising a pushbutton making it possible, each time the button is pressed, to suck air into the at least one sucker.

2. The shutter as claimed in claim 1, wherein the pump is connected to each of the associated at least one sucker using a flexible pipe.

3. The shutter as claimed in claim 1, further comprising a second vacuum pump, the at least one pump and the second pump arranged for the handling of the shutter by grasping with one hand the handle of the at least one pump and with the other hand the handle of the second pump, one or more suckers being associated with the corresponding pump.

4. The shutter as claimed in claim 1, wherein the skirt comprises a seal fixed to the panel so as to form said enclosure.

5. The shutter as claimed in claim 1, wherein the skirt comprises a brush of threads fixed to the panel so as to form said enclosure.

6. The shutter as claimed in claim 5, wherein the brush is closed on itself so as to form an enclosed surface.

7. The shutter as claimed in claim 4 , wherein the skirt comprises a brush of threads fixed to the panel so as to form said enclosure, and
wherein the brush forms an enclosed surface surrounding that of the seal.

8. The shutter as claimed in claim 5, wherein the brush comprises a double row of threads.
